(19) United States
(12) Patent Application Publication
(10) Pub. No.: US 2017/0006817 A1
(43) Pub. Date: Jan. 12, 2017

(54) DAIRY FARMING SYSTEM

(71) Applicant: LELY PATENT N.V., Maassluis (NL)

(72) Inventors: Serge Louis LOOSVELD, Maassluis (NL); Comelis Christianus Francis HAVERMANS, Maassiuis (NL)

(73) Assignee: LELY PATENT N.V., Maassluis (NL)

(21) Appl. No.: 15/119,326

(22) PCT Filed: Jan. 20, 2015
(86) PCT No.: PCT/NL2015/050034

§ 371 Date: Aug. 16, 2016

(30) Foreign Application Priority Data
Feb. 17, 2014 (NL) 2012276

(51) Int. Cl. A01J 5/007; A01J 5/013; A01J 7/00

(52) U.S. Cl. CPC A01J 5/007; A01J 7/00; A01J 5/0131

(57) ABSTRACT

A dairy farming system comprises at least one milking device for obtaining milk from dairy animals by means of a milking process, a control unit for controlling the at least one milking device, and a data input for automatically receiving data relating to milk which was obtained earlier and supplied to an external party. The data comprises at least one content of a substance in the milk and/or at least one physical or chemical property of the milk, and a quantity value of the milk, the milking device has at least one adjustable parameter relating to the milking process, the control unit automatically processes at least part of the received data to obtain at least one control parameter value, and the control unit automatically adjusts at least one of the at least one parameter of the milking device on the basis of the at least one control parameter value.

The invention relates to a dairy farming system comprising at least one milking device for obtaining milk from dairy animals by means of a milking process, and a control unit for controlling the at least one milking device.

Such dairy farming systems are generally being used to obtain milk from dairy animals. The control unit may in this case adjust the milking device to each individual animal, for example regarding pulsation frequency, pretreatment etc.

Until now, no use has been made of knowledge of the dairy animals to optimize this adjustment in a simple and easy way.

It is therefore an object of the present invention to facilitate and at the same time optimize the adjustment of the milking device.

The invention achieves this object by means of a dairy farming system as claimed in claim 1, and in particular comprising at least one milking device for obtaining milk from dairy animals by means of a milking process, and a control unit for controlling the at least one milking device, wherein the dairy farming system comprises a data input for automatically receiving data relating to milk which was obtained earlier and supplied to an external party, wherein the data originate from the external party and comprise at least one content of a substance in the milk and/or at least one physical or chemical property of the milk, in particular also comprising a quantity value of the milk, wherein the milking device has at least one adjustable parameter relating to the milking process, wherein the control unit is configured to automatically process at least part of the received data to obtain at least one control parameter value, wherein the control unit is configured to automatically adjust at least one of the at least one parameter of the milking device on the basis of the at least one control parameter value. The invention also relates to a dairy farming system as claimed in claim 2, and in particular comprising at least one milking device for obtaining milk from dairy animals by means of a milking process, at least one animal-related peripheral device for carrying out an animal-related peripheral process, which is not milking, and a control unit for controlling the at least one peripheral device, wherein the dairy farming system comprises a data input for automatically receiving data relating to milk which was obtained earlier and supplied to an external party, wherein the data originate from the external party and comprise at least one content of a substance in the milk and/or at least one physical or chemical property of the milk, in particular also comprising a quantity value of the milk, wherein the peripheral device has at least one adjustable parameter relating to the peripheral process, wherein the control unit is configured to automatically process at least part of the received data to obtain at least one control parameter value, wherein the control unit is configured to automatically adjust at least one of the at least one parameter of the peripheral device on the basis of the at least one control parameter value. Behind these aspects of the invention is the overarching thought that it is thus possible to use high-quality measurements which the external party carries out in an optimum way. After all, this offers the advantage of top-quality equipment, and therefore also more reliable and accurate data are available for the milking device or peripheral device without having to furnish the dairy farming system itself with said top-quality equipment. For the latter, less expensive equipment of lower quality will suffice. By in addition automatically supplying these data to the dairy farming system, the latter is able to profit in the fastest possible way of the information relating to the (milk of the) dairy animals provided by the measurement results. This ensures, for example, improved milk yield, in quantity and/or quality, improved animal health, lower costs, etc. An interpretation stage by a user is not required in this case, although it can obviously be carried out in addition. This furthermore reduces the risk of misinterpretations which would lead to incorrect settings of the milking device or peripheral device.

The at least one adjustable parameter of the milking device and/or the peripheral device relates to a physical quality of the milking process, to whether or not to carry out the milking process, or to an animal-related process which may affect the milk yield with regard to quality or quantity. Such processes relate in particular to a supply or rate of feed to an animal or group of animals, but also, for example, to processes relating to animal health or animal welfare, such as mastitis treatment, claw treatment, etc., but also to a reproduction process of the dairy animal, which is after all a requirement for milk yield and is also often incorporated in the management. All processes which may influence the milk yield may in turn at least partly be controlled by that influence they have on the milk.

The control parameter value may simply be a measured value in the milk or be a value which is based on and derived from one or more values measured in the milk. All this will be explained in more detail below.

Particular embodiments of the invention are described in the subclaims, as well as in the description below.

In embodiments, the peripheral device comprises an animal identification device, such as a tag reader. Thus, the possibility has been created to adjust a parameter to each individual animal. However, it is also possible to adjust this parameter for all animals of a group, so that an animal identification device is not always required.

According to the invention, the control unit is configured to automatically process at least part of the received data to obtain at least one control parameter value, wherein the control unit is configured to automatically adjust at least one of the at least one parameter of the milking device on the basis of the at least one control parameter value. To this end, the control unit comprises a data-receiving device for automatically receiving the data to be received. This device comprises, for example, a network connection to the external party, whose data are (may be) received, and is for example configured in such a way that this external party is able to log onto the network as soon as there are data to be sent to the dairy farming system. Thus, the data can be directly received by the control unit or another part of the dairy farming system, and can also be processed further to obtain a control parameter value. Alternative ways of receiving and processing data are, for example, as an attachment to an email which is automatically stored and processed, etc. It should be noted that the point in time at which these data arrive does not have to be fixed, and that even, for example, the days may vary, and that the time of day when the data arrive does not have to be fixed either. However, it is possible to make arrangements in this respect. This point in time could, for example, be close to a point in time during the day when other dairy animal data or adjustment data are being updated, so that all adjustments could be processed by the control unit at the same time. The update data relate to, for example, assignment to a different group of the dairy animal, a treatment that was performed, etc.

In embodiments, the peripheral device comprises a feed device which is configured to dispense feed, in particular concentrate, to the dairy animals. Dispensing feed is a very direct way of influencing the milking process, or the milk yield. The peripheral device in this case comprises, as in all embodiments, an operative coupling to the control unit to allow the latter to adjust one or more parameters of the peripheral device with the aid of the control parameter(s). Examples of parameters which can be adjusted in a feed device are the amount of feed per feed dose, the amount of feed per day, the minimum time between two feed doses, the kind of composition of the feed, etc.

In particular, the feed device comprises a concentrate station and/or a system which is configured to dispense roughage. Concentrate stations dispense concentrate to dairy animals. This already takes place individually for each animal on a large scale. The invention provides the advantage that the setting can be adjusted very quickly and automatically. In addition, roughage is nearly always provided, such as hay or corn. This is often dispensed ad libitum, but, also in this case, it may be advantageous to regulate this, at least at group level or even at individual level. An example of a device which is able to automatically dispense roughage at least at group level is the Lely Vector™ system. It should be noted that the groups of animals generally have to be physically separated in this case, but it is also possible to regulate dispensation of roughage at a group level by using controls at a feed-dispensing location, such as controlled feed fences.

According to the invention, the received data comprise at least one content of a substance in the milk and/or at least one physical or chemical property of the milk. Both contents of substances in the milk and physical or chemical properties may give valuable information for regulating a milking process or animal-related peripheral process. In many cases, the content of a substance will have to be kept as high or as low as possible. In addition, there are also requirements, for example, regarding the freezing point of the milk or other physical properties, such as color. Chemical properties which may be connected, for example, to the flavor, may also be important in obtaining the milk. The data may therefore also comprise values of such physical or chemical properties.

In particular, the received data also comprise a quantity value of the milk. It will be clear that this is an important variable in dairy farming.

In embodiments, the received data comprise a content in the milk obtained of at least one of fat, somatic cells, free fatty acids, urea, protein and lactose. Such contents are important to a dairy farmer, because the remuneration for the milk may depend directly from such contents, both in a positive sense, such as for fat and protein, and in a negative sense, such as for somatic cells. There are also substances which form an indication of an aspect of the metabolism. For example, the urea content is an indication for the efficiency of the metabolism, which may yield valuable information for regulating the feed dose. However, other contents are certainly also possible, such as the contents of particular substances in the milk, such as substances which are typical for the animal species or even for the animal in question, which is, for example, a genetically manipulated animal. Particularly with such rare or expensive animals, it is particularly important to optimize their yield, and quick automatic adjustments may bear fruit.

In embodiments, the received data also comprise external milk data which originate from at least one external dairy farming system, as well as at least one value of an adjustable parameter of said external dairy farming system associated with the external milk data. The advantage thereof is that it is also possible to use data of other parties, which may increase the total to a much larger number. This often renders, for example, a statistical analysis much more robust and/or accurate. It is also possible to be able to choose from many different settings or parameter values simultaneously, so that the optimum setting(s) for the present dairy farming system can be found in a reliable and efficient way. In particular cases, it is possible to use a further, that is to say additional, milking device of the dairy farming system as external dairy farming system. In this case, the milking devices are considered to be independent of one another and are also controlled in such a way. However, in practice, the milking devices will often be controlled by one and the same control unit, so that they cannot be considered to be independent. However, it is also possible to involve data from an external, completely different dairy farming system. Preferably, said external dairy farming system has a similar device to the present dairy farming system. In particular, the external dairy farming system has a similar milking device and/or a similar peripheral device, such as a feed device. The expression “similar” is understood to mean “having the same function”, such as milking, feeding or the like. In particular, the respective similar devices are by the same brand or even of the same type. This makes processing data from the external dairy farming system to obtain a control parameter for the present dairy farming system simpler, because no additional translation step for the hardware or software is required. The external parameter may in this case also relate to a milking device or an animal-related peripheral device.

In embodiments, the control unit is configured to process the external data at one or more predetermined points in time. This not only comprises receiving and collecting external data at the predetermined moment(s) and processing them in real time, but also receiving or collecting data at arbitrary points in time, storing them until the soonest of the predetermined moments, and subsequently processing them to obtain a control parameter or the like. For example, it is thus possible to match the point in time when the external data are processed to a management routine of a farmer who, for example likewise at fixed points in time, such as every morning and/or every evening, updates a database or the like relating to the dairy animals and/or the system. Thus, the control unit can process all the changes in one instance. Obviously, other fixed processing times are also possible, such as once a week or month, for example if it is desired not to confront the dairy animals, which are also creatures of habit, with changes too often. In other embodiments, the control unit is configured to process the external data upon receipt. With these embodiments, the system according to the invention is able to use the speed of processing external data in an optimum manner, and is therefore also able to implement any improvements which may be the result of these adjustments as quickly as possible.

In embodiments, the obtained and supplied milk comprises milk samples and the external party comprises a laboratory for milk. In this case, the milk samples will virtually always be coupled to the identity of the respective dairy animals, although it is not impossible for the sample of tank milk to be taken in its entirety. In case of individualized samples, the settings, control parameter values can in principle be chosen for each animal, but this can also be done at group level. In any case, the samples comprise milk which has been separated from milk (for consumption) supplied to a different destination, but also the milk that is supplied, namely to the external party which inspects the samples. It should be noted that no direct quantity value can be determined with samples. However, this may be obtained from other sources, although usually not external.

Alternatively or additionally, the obtained and supplied milk comprises milk for consumption and the external party comprises a dairy factory. Supplying such milk for consumption is the main objective of dairy farms. The dairy factory may, for example, produce milk, but also milk products, such as UHT milk, skimmed or semi-skimmed milk or products derived from milk, such as yoghurt and other dairy desserts, cheese and the like. Since the milk supplier has to be remunerated, at least the quantity value will always be determined and passed on. However, in theory this value is already known on the dairy farming system itself, either from a bulk tank meter or from milk meter values which have been added up. In many, if not all, cases, the dairy factory will also examine the quality of the supplied milk and will determine one or more contents in the course thereof. These values are often communicated to the milk supplier, but in many cases nothing much was done with them, least of all in a direct, automatic way. However, it should be noted that these contents virtually always apply to group or herd level.

In embodiments, the automatic processing of the data comprises comparing the data to an associated reference value and determining the control parameter value according to a predetermined criterion. Comparing the data to an associated reference value may, inter alia, comprise comparison to a predetermined fixed value or also to a desired range, for example a minimum freezing point for the milk or a minimum desired fat percentage. The subsequent determination of the control parameter value may be effected according to any desired criterion. For example, a control parameter may be set on the basis of a urea content or milk urea nitrogen content. Thus, a urea content may be above a certain range of, for example, 0.1-0.15 g/l, which may be an indication, for example, that the feed contains too much nitrogen. In this case, it is for example possible to use as criterion for the control parameter that if the urea content is between 0.10 g/l and 0.15 g/l to use a value of 0 for the control parameter, and to use a value of −1 if the urea content is over 0.15 g/l. At said value of “−1”, a feed adjustment is for example carried out, while this is not the case with “0”. Obviously, more complicated criteria and settings are possible. It may be particularly advantageous to use several different milk contents. In addition, it is certainly also possible to use other parameter values which have not been found in the supplied milk, but come, for example, directly from the cow, such as body weight, etc. It is also possible to determine the control parameter on the basis of the received data and a predetermined model. Examples are linear or other regression models, as well as a model for so-called dynamic linear programming. In this case, as a first step, a control parameter is changed in such a way with respect to an initial value that this will result in a change in the parameter values. By examining how much the the parameter values change, it is possible to determine an optimization of the settings, via the control parameter value.

The present invention will now be explained in more detail with reference to the drawing, in which the sole FIGURE shows a dairy farming system according to the invention in diagrammatic top view.

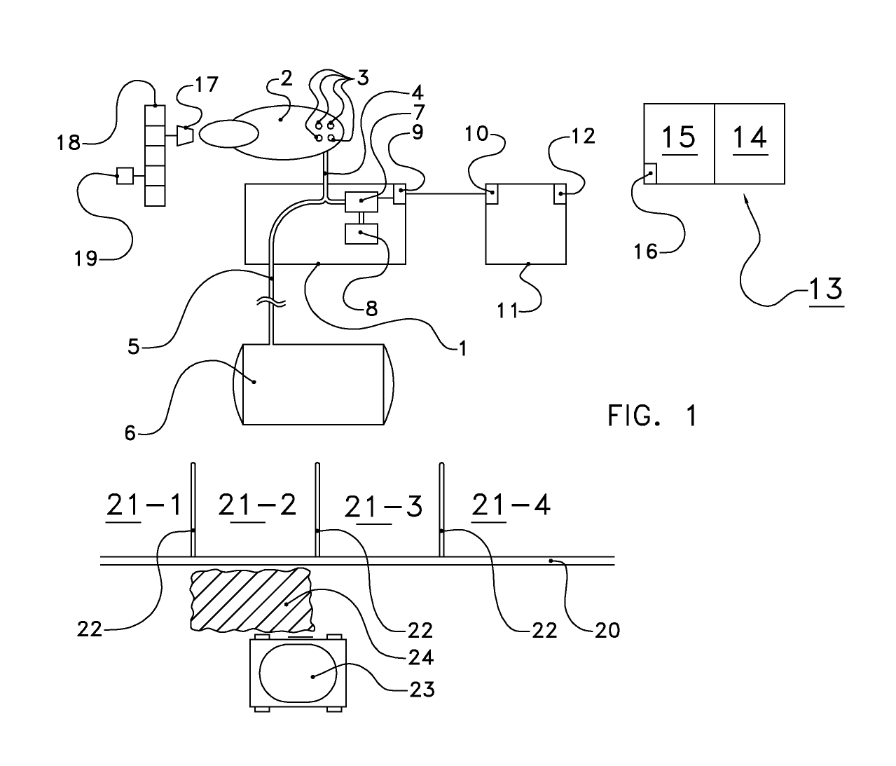

FIG. 1 shows a dairy farming system according to the present invention in diagrammatic top view.

The system comprises a milking device 1 for milking a dairy animal 2 having teats 3. The milk obtained passes to the milk tank 6 via milk line 4 and main milk line 5, and a sample thereof goes to the sampling device 7 which is connected to a sample store 8. Furthermore, the milking device 1 comprises a communication device 9 for communicating with the communication device 10 of the control unit 11 which also comprises a data input device 12 for automatically inputting data from an external test device 13 which is provided with a sample intake 14, a data-processing device 15 and a communication device 16.

In addition, the FIGURE shows a feed trough 17 comprising a feed-providing device 18 and a feed control unit 19, as well as a feeding fence 20 with feeding stations 21-1 to 21-4, separated by fencing 22, and provided with roughage 24 by means of a feeding vehicle 23.

In use, the milking device 1 will milk a dairy animal 2 having teats 3. The milk obtained enters via the milk line 4 and then passes via the main milk line 5 to the milk tank 6. A sample of the milk obtained is taken and sampled in the sampling device 7. This may comprise one or more analyzing devices, such as a conductivity meter, a somatic cell counter (SCC), a color meter, an optical transmission meter, etc. Details regarding these analyzing devices can be found in the prior art. Alternatively or additionally, a sample can be stored in the sample store 8, after which this sample may be put at the disposal of, for example, an external laboratory in order to perform accurate measurements.

An example of such a test institute is shown (diagrammatically) in the external test device 13. It comprises a sample intake 14, where the one or more samples from the sample store 8 can be analyzed using accurate analyzing equipment, such as laboratory equipment. The measurement data of the equipment are collected and processed in the data-processing device 15 and are automatically made available by means of the communication device 16.

The communication device 16 is configured to automatically pass the processed data to the data input device 12 of the control unit 11 of the milking device 1, for example by automatically logging into the control unit 11 via a network. It should be noted that the supply of the samples is usually not automated (yet), but that it is nevertheless possible to achieve a (considerable) time saving and increase in reliability.

The control unit 11 is configured to control at least the milking device 1. Controlling comprises, for example, an access criterion for the dairy animal 2, the milking regime, that is to say a milking vacuum, a pulsation vacuum and/or pulsation frequency, a pretreatment time, a feed dose in the feed trough 17, etc. It should be noted that constructive details of the milking device 1, such as milking cups, a robot arm, teat-detecting means, etc. are not shown. Details about these can readily be found in the specialist literature by those skilled in the art.

The invention offers advantages when processing the data of the samples as the measurement results are automatically made available to the control unit 11. As a result thereof, the control unit 11 may automatically, that is to say without interference or interpretation by an operator, process these data to obtain one or more settings for milking an individual dairy animal 2. Thus, least time is lost when operating and adapting the control unit 11, and the risk of errors by the device is also reduced. In particular with large numbers of dairy animals per dairy farm, the risk of the wrong data being input or data being erroneously swapped is considerable and inputting the data would take an unnecessarily long time in any case. In addition, it is interesting to also take control measures, such as adjusting parameter values in the milking regime, feed regime, etc. even with small changes in the measured values of the milk samples. As an example of a control parameter, a control parameter for automatically varying the feed dose in the feed trough 17 by adjusting the composition and/or the amount which is provided by the feed-providing device 18 is mentioned. By examining the effects on, in particular, the milk, per herd, animal group or individual animal, it is also possible to optimize a desired parameter value for each respective group/individual. An example of a parameter value which can be optimized relates to the amount of milk, the fat or protein content of the milk, or the feed efficiency. Optimization may be achieved by maximizing the value and by accordingly regulating the feed dose, the milking regime, etc. or also by, for example, optimizing the value by comparing it to an associated reference value, which may be an individual value or an individual range, and adjusting the control parameter value (feed dose, milking regime, etc.) in order to achieve this value or range.

An embodiment has been illustrated above in particular, in which the data relating to the milk samples are used to adjust the milking device, optionally using direct peripheral equipment, such as concentrate-providing devices in the milking robot. However, it is also possible to automatically use the data relating to the milk samples in order to control other devices on the dairy farm. An example thereof is also shown in FIG. 1 and relates to a device for supplying roughage. In this case, it comprises a feeding fence 20 with different feeding stations 21-1, 21-2, 21-3 and 21-4, separated by fences 22. This feeding fence 20 with the feeding stations 21 is configured to individualize the roughage dose. To this end, the feeding fence 20 is configured, for example, to only make it possible, for each feeding station 21, for individual animals or animal groups to pass the head through the feeding fence 20 to reach the roughage provided in front of the respective feeding station 21. This may be achieved, for example, by means of individual openable and closable apertures which are operated by means of an animal-identification system which reacts, for example, to the RFID tag in the collar of the animal. It is also possible to make the feeding stations 21 accessible by means of ID-controlled access fences. One of the simplest ways of ensuring individual roughage doses is to keep animals or groups of animals in individual, closed spaces. Whatever the case may be, it is possible to supply roughage 24 separately for each feeding station 21-1 to 21-4, in this case by means of an, optionally autonomous, feeding vehicle 23. An example of the latter is the Lely Vector® system.

The data which are provided to the control unit 11 by the communication device 16 can be used, after processing in the control unit, to operate the feeding vehicle 23 or a device (not shown here) to load roughage onto the feeding vehicle 23. The advantages whereby any adjustment of the roughage dose by, for example, the feeding vehicle 23 can be carried out automatically and quickly and whereby other adjustments, such as control by means of a DLM, can also be carried out automatically and quickly also apply in this case.

In an alternative embodiment, data are received which relate to the bulk milk from the milk tank 6, as determined by, for example, the dairy producer to whom it was supplied. He will also be able to perform reliable measurements by means of accurate equipment, which values may be useful for adjusting the parameter values of the dairy farming system.

Another alternative embodiment relates to one in which the external device does not relate to a laboratory, but to one or more other milking devices. In principle, this may also be milking devices on one and the same dairy farm, but these will often already be coupled to the milking device 1. Alternatively or additionally, however, it is possible to use data from other dairy farms which use a similar milking device to milking device 1. The data which have been obtained with the respective sampling devices of the external milking devices can then be used for the milking device 1 of the system shown in FIG. 1. Alternatively, and advantageously, the received data may relate to these external milking devices, but originate from the same external party (laboratory, dairy producer) which performs the measurements. In this way, not only is a much greater amount of data made available, but this is also effected automatically and quickly. This results in more and quicker flexibility to adjust the settings of, for example, the milking system 1 as well as of feed-providing devices 18 and feeding vehicles 23.

1. A dairy farming system, comprising:
at least one milking device for obtaining milk from dairy animals by means of a milking process;
a control unit for controlling the at least one milking device; and
a data input for automatically receiving data relating to milk which was obtained earlier and supplied to an external party, wherein
the data originates from the external party and comprises at least one content of a substance in the milk and/or at least one physical or chemical property of the milk, in particular also comprising a quantity value of the milk,
the milking device has at least one adjustable parameter relating to the milking process,
the control unit is configured to automatically process at least part of the received data to obtain at least one control parameter value, and
the control unit is configured to automatically adjust at least one of the at least one parameter of the milking device on the basis of the at least one control parameter value.

2. A dairy farming system, comprising:
at least one milking device for obtaining milk from dairy animals by means of a milking process;
at least one animal-related peripheral device for carrying out an animal-related peripheral process, which is not milking;
a control unit for controlling the at least one animal-related peripheral device; and
a data input for automatically receiving data relating to milk which was obtained earlier and supplied to an external party, wherein
the data originates from the external party and comprises at least one content of a substance in the milk and/or at least one physical or chemical property of the milk, in particular also comprising a quantity value of the milk,
the at least one animal-related peripheral device has at least one adjustable parameter relating to the peripheral process,
the control unit is configured to automatically process at least part of the received data to obtain at least one control parameter value, and
the control unit is configured to automatically adjust at least one of the at least one parameter of the animal-related peripheral device on the basis of the at least one control parameter value.

3. The dairy farming system as claimed in claim 2, wherein the at least one animal-related peripheral device comprises a feed device which is configured to dispense feed, in particular concentrate, to the dairy animals.

4. The dairy farming system as claimed in claim 3, wherein the feed device comprises a concentrate station and/or a system which is configured to dispense roughage.

5. The dairy farming system as claimed in claim 1, wherein the received data comprises a content in the milk obtained of at least one of fat, somatic cells, free fatty acids, urea, protein and lactose.

6. The dairy farming system as claimed in claim 1, wherein the received data comprises external milk data which originate from at least one external dairy farming system, as well as at least one value of an adjustable parameter of said external dairy farming system associated with the external milk data.

7. The dairy farming system as claimed in claim 1, wherein the obtained and supplied milk comprises milk samples and the external party comprises a laboratory for milk.

8. The dairy farming system as claimed in claim 1, wherein the obtained and supplied milk comprises milk for consumption and the external party comprises a dairy factory.

9. The dairy farming system as claimed in claim 1, wherein the automatic processing of the data comprises comparing the data to an associated reference value and determining the control parameter value according to a predetermined criterion.
